(19) United States
(12) Patent Application Publication
(10) Pub. No.: US 2010/0158721 A1
(43) Pub. Date: Jun. 24, 2010

(54) HERMETIC COMPRESSOR AND METHOD OF MANUFACTURING THE SAME

(75) Inventors: Seigo Yanase, Kanagawa (JP); Akihiko Kubota, Kanagawa (JP); Atsushi Naruse, Kanagawa (JP); Kiwamu Watanabe, Kanagawa (JP); Hironari Akashi, Kanagawa (JP); Yoichiro Nakamura, Kanagawa (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Osaka (JP)

(21) Appl. No.: 12/160,619

(22) PCT Filed: Nov. 30, 2007
(86) PCT No.: PCT/JP2007/073618

§ 371 Date: Jul. 11, 2008

(30) Foreign Application Priority Data
Dec. 1, 2006 (JP) 2006-325197
Feb. 5, 2007 (JP) 2007-025026

(51) Int. Cl. F04B 35/04; B23P 11/00; F04B 39/02

(52) U.S. Cl. 417/415; 29/592.1

(57) ABSTRACT

Provided is a hermetic compressor in which an electric element having a stator and rotor provided therein and a compression element driven by the electric element are housed and the compression element includes a shaft which has a main shaft portion and an eccentric shaft portion, a cylinder block, a main shaft bearing which is formed in the cylinder block and supports the main shaft bearing of the shaft, a piston which reciprocates, a connection mechanism which connects the piston to the eccentric shaft portion, and a thrust-ball bearing, the thrust ball bearing having a plurality balls and a holder portion for holding the balls, and the holder portion being formed of polymer obtained by polycondensating diaminobutane and adipic acid.

### TECHNICAL FIELD

The present invention relates to a hermetic compressor which is used in a refrigeration system and so on.

### BACKGROUND ART

Recently, in a hermetic compressor used in refrigeration systems such as a refrigerator and so on, high efficiency, reduction in noise, and high reliability are required so as to reduce power consumption.

Conventionally, this kind of hermetic compressor has a structure that a thrust-ball bearing is adopted to increase efficiency and a shaft can be freely rotated with respect to a main shaft bearing (for example, refer to Patent Documents 1 and 2).

Hereinafter, the conventional compressor will be described with reference to drawings.

FIG. 9 is a vertical cross-sectional view of the conventional hermetic compressor disclosed in Patent Document 1. FIG. 10 is an expanded view of essential parts of FIG. 9.

As shown in FIGS. 9 and 10, electric element 2 composed of stator 52 and rotor 54 and compression element 4, which is rotationally driven by electric element 2, are housed in hermetic vessel 1, and lubricant oil 6 is stored in the bottom portion of hermetic vessel 1. Electric element 2 and compression element 4 are integrally assembled so as to form compression mechanism 8, and compression mechanism 8 is elastically supported by a plurality of coil springs (not shown) in hermetic vessel 1.

In cylinder block 20 composing compression element 4, cylindrical compression chamber 22 is formed, and piston 24 is fitted into compression chamber 22 so as to freely reciprocate. Main shaft bearing 26 is fixed to the upper portion of cylinder block 20, and slide surface 28 is formed in the upper side of main shaft bearing 26.

Shaft 30 includes main shaft portion 34, which is supported in a vertical direction by main shaft bearing 26 and has spiral groove 32 formed in the outer circumference thereof, and eccentric shaft portion 36 formed under main shaft portion 34. Further, oil feeding pipe 42 is pressed into an oil feed hole (not shown) formed in lower end 38 of eccentric shaft portion 36, and eccentric shaft portion 36 and piston 24 are connected through connection mechanism 44.

One end of oil feeding pipe 42 communicates with spiral groove 32 from the oil feed hole, and lower end opening portion 46 is opened in lubricant oil 6.

Electric element 2 is fixed to the upper side of cylinder block 20 and is composed of stator 52 having winding wire 50 formed thereon and rotor 54 fixed to main shaft portion 34 of shaft 30 through shrinkage fit.

Bore plane 58 is formed within counter bore 56 which is a concave portion of lower portion 55 of rotor 54, and thrust surface 28 is formed on the upper end of main shaft bearing 26. Between bore plane 58 within counter bore 56 and thrust surface 28, thrust-ball bearing 60 is disposed so as to support shaft 30.

Thrust-ball bearing 60 includes a plurality of balls 62, holder portion 64 for holding balls 62, and upper and lower laces 66 and 68 disposed on and under balls 62. Further, upper lace 66 is contacted with bore plane 58, and lower lace 68 is contacted with thrust surface 28.

Holder portion 64 of thrust-ball bearing 60 is formed of polymer (hereinafter, referred to as ‘polymer A’) which is obtained by polycondensating hexamethylene diamine and adipic acid.

Now, the operation of the hermetic compressor constructed in such a manner will be described.

When electric power is supplied to electric element 2 from an external power supply (not shown), rotor 54 is rotated, and shaft 30 is rotated in accordance with the rotation of rotor 54. Then, as the rotation of eccentric shaft portion 36 is transmitted to piston 24 through connection mechanism 44, piston 24 reciprocates inside compression chamber 22 such that compression element 4 performs a predetermined compression operation.

Accordingly, refrigerant gas is sucked into compression chamber 22 from a cooling system (not shown) so as to be compressed. Then, the refrigerant gas is again discharged into the cooling system.

At this time, oil feeding pipe 42 pumps up lubricant oil 6 by using a centrifugal force such that respective sliding portions (not shown) are lubricated. Then, some of lubricant oil 6 is supplied to thrust surface 28 from spiral groove 32 such that thrust-ball bearing 60 is lubricated.

The weight of shaft 30 and rotor 54 is supported by thrust-ball bearing 60. Further, when shaft 30 is rotated, balls 62 are rolled between upper lace 66 and lower lace 68. Accordingly, torque which rotates shaft 30 supported by thrust-ball bearing 60 is reduced in comparison with that of a thrust sliding bearing. Therefore, a loss in the thrust bearing can be reduced, and an input can be reduced, which makes it possible to perform the compression operation with high efficiency.

Further, another conventional hermetic compressor different from the above-described hermetic compressor will be described with reference to FIGS. 11 and 12.

FIG. 11 is a vertical cross-sectional view of the conventional hermetic compressor disclosed in Patent Document 2. FIG. 12 is an expanded view of essential parts of FIG. 11.

As shown in FIGS. 11 and 12, electric element 108 composed of stator 104 and rotor 106 and compression element 110, which is rotationally driven by electric element 108, are respectively housed in a hermetic vessel 102. Further, lubricant oil 112 is stored in the bottom portion of hermetic vessel 102. Further, electric element 108 and compression element 110 are integrally assembled so as to form compression mechanism 114. Further, compression mechanism 114 is elastically supported by a plurality of coil springs 116 in hermetic vessel 102.

Compression element 110 includes shaft 126 having eccentric shaft portion 124 formed through main shaft portion 120 and flange portion 122, cylinder block 132 forming compression chamber 130, and main shaft bearing 134 which is provided in cylinder block 132 so as to support shaft 126. Further, compression element 110 includes piston 136 which reciprocates inside compression chamber 130 and connection mechanism 138 which connects piston 136 to eccentric shaft portion 124. Further, compression element 110 includes upper lace receiving surface 142 provided on lower portion 139 of flange portion 122 of shaft 126 at substantially right angles to axis center 140 of main shaft portion 120, upper end surface 144 provided in the upper portion of main shaft bearing 134 at substantially right angles to axis center 140 of main shaft bearing 134, and thrust-ball bearing 146 provided between upper lace receiving surface 142 and upper end surface 144, thereby forming a reciprocating-type compressor.

Further, shaft 126 includes oil feeding mechanism 150 having one end communicating with lubricant oil 112 stored in hermetic vessel 102 and oil feed groove 152 formed on main shaft portion 120. The oil feed groove 152 supplies some of lubricant oil 112, pumped up by oil feeding mechanism 150, to upper end surface 144.

Electric element 108 is composed of stator 104 fixed to the lower side of cylinder block 132 and rotor 106 fixed to main shaft portion 120 through shrinkage fit or the like.

As shown in FIG. 12, thrust-ball bearing 146 includes a plurality of balls 160, holder portion 162 for holding balls 160, and upper and lower laces 164 and 166 disposed on and under balls 160. Further, upper lace 164 is contacted with upper lace receiving surface 142 of flange portion 122, and lower lace 166 is contacted with upper end surface 144.

Holder portion 162 of thrust-ball bearing 146 is formed of polymer A obtained by polycondensating hexamethylene diamine and adipic acid, like the holder portion described in Patent Document 1.

Now, the operation of the hermetic compressor constructed in such a manner will be described.

When electric power is supplied to electric element 108 from an external power supply (not shown), rotor 106 is rotated, and shaft 126 is rotated in accordance with the rotation of rotor 106. Then, as the rotation of eccentric shaft portion 124 is transmitted to piston 136 through connection mechanism 138, piston 136 reciprocates inside compression chamber 130 such that compression element 110 performs a predetermined compression operation.

Accordingly, refrigerant gas is sucked into compression chamber 130 from a cooling system (not shown) so as to be compressed. Then, the refrigerant gas is again discharged into the cooling system.

At this time, oil feeding mechanism 150 of shaft 126 pumps up lubricant oil 112 such that respective sliding portions (not shown) are lubricated. Further, some of lubricant oil 112 is supplied to upper end surface 144 from oil feed groove 152 such that thrust-ball bearing 146 is lubricated.

The weight of shaft 126 and rotor 106 is supported by thrust-ball bearing 146. Further, when shaft 126 is rotated, balls 160 are rolled between upper lace 164 and lower lace 166. Accordingly, torque which rotates shaft 126 supported by thrust-ball bearing 160 is reduced in comparison with that of a thrust sliding bearing. Therefore, a loss in the thrust bearing can be reduced, and an input can be reduced, which makes it possible to perform the compression operation with high efficiency.

However, in the conventional hermetic compressors disclosed in Patent Document 1 and Patent Document 2, when continuous operating time is lengthened so that the temperature of hermetic vessel 1 or 102 increases, an input could be increased. Therefore, the hermetic compressor in which an input is large has been disassembled so as to examine the cause why an input becomes large. As a result, it has been found that adhering matters are generated on track surfaces on which balls 62 or 160 of upper lace 66 or 164 and lower lace 68 or 166 are rolled, and floating matters are generated in lubricant oil 6 or 112.

With a result that the components of the adhering matters and the floating matters are analyzed, the components coincide with the components of holder portion 64 or 162 of thrust-ball bearing 60 or 146. Accordingly, it has been proved that the adhering matters and the floating matters are lower polymer (hereinafter, referred to as ‘oligomer’) which is eluted from holder portion 64 or 162.

Further, a shield tube test has been performed, in which a refrigerant and lubricant oil are put into the hermetic vessel sealing holder portion 64 or 162 and are then heated at a high temperature. Similar to the result of the component analysis of the adhering matters and the floating matters, it has been found in the shield tube test that the oligomer is eluted in the lubricant oil.

Meanwhile, in the hermetic compressor which is operated for short continuous operating time, that is, under an operation condition where the temperature of hermetic vessel 1 or 102 does not increase, an input is not increased, and the above-describe oligomer is not generated. Therefore, it has been found that as the oligomer is generated, the input of the hermetic compressor is increased.

That is, it is considered that when the hermetic compressor is operated, balls 62 or 160 are hardly rolled due to the resistance caused by the oligomer adhering to the track surfaces of upper lace 66 or 164 and lower lace 68 or 166. Further, as the input of the hermetic compressor is increased, the oligomer eluted in lubricant oil 6 or 112 is sucked with lubricant oil 6 or 112 through oil feeding pipe 42 or oil feeding mechanism 150. In such a state, since the oligomer adheres to the respective sliding portions such as shaft 30 or 126, main shaft bearing 26 or 134 and so on, sliding resistance increases. As a result, a generated amount of heat increases, so that the temperature of hermetic vessel 1 or 102 increases. Further, the reliability of the hermetic compressor may be degraded.
Patent Document 1: Japanese Patent Unexamined Publication No. 61-53474
Patent Document 2: Japanese Patent Unexamined Publication No. 2005-127305

### DISCLOSURE OF THE INVENTION

An advantage of the present invention is that it provides a high-efficiency and reliable hermetic compressor which prevents oligomer from being generated from a holder portion, even when the hermetic compressor is operated in such a manner the temperature thereof increases, and suppresses an increase in input.

In the hermetic compressor of the invention, a holder portion of a thrust-ball bearing is formed of polymer (hereinafter, referred to as ‘polymer B’) obtained by polycondensating diaminobutane and adipic acid. The polymer B forming the holder portion has excellent heat resistance, oil resistance, and refrigerant resistance. Therefore, although the temperature of the holder portion increases due to an operation condition, it is possible to prevent oligomer from being eluted from the holder portion. Therefore, the oligomer eluted by lubricant oil does not adhere to track surfaces of upper and lower laces, and it can be prevented that balls are hardly rolled.

As a result, even under a condition where the temperature of the hermetic compressor excessively increases, the oligomer eluted by the lubricant oil is not accumulated as adhering matters on the track surfaces of the upper and lower laces, and heat caused by the adherence of oligomer is not generated. Therefore, it is possible to implement a high-efficiency and reliable hermetic compressor which can suppress an increase in input.

### BRIEF DESCRIPTION OF THE DRAWINGS

FIG. 1 is a vertical cross-sectional view of a hermetic compressor according to a first embodiment of the present invention.

FIG. 2 is an expanded view of essential parts of the hermetic compressor according to the first embodiment of the present invention.

FIG. 3 is a vertical cross-sectional view of a rotor according to the first embodiment of the invention.

FIG. 4 is a plan cross-sectional view of the rotor according to the first embodiment of the invention.

FIG. 5 is a vertical cross-sectional view of a hermetic compressor according to a second embodiment of the invention.

FIG. 6 is an expanded view of essential parts of the hermetic compressor according to the second embodiment of the invention.

FIG. 7 is a vertical cross-sectional view of a rotor according to the second embodiment of the invention.

FIG. 8 is a plan cross-sectional view of the rotor according to the second embodiment of the invention.

FIG. 9 is a vertical cross-sectional view of a conventional hermetic compressor.

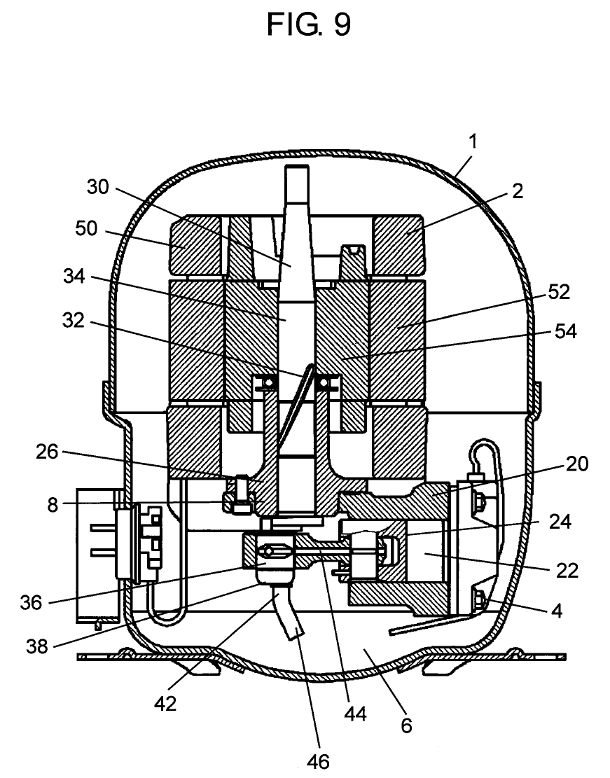

FIG. 10 is an expanded view of essential parts of the conventional hermetic compressor.

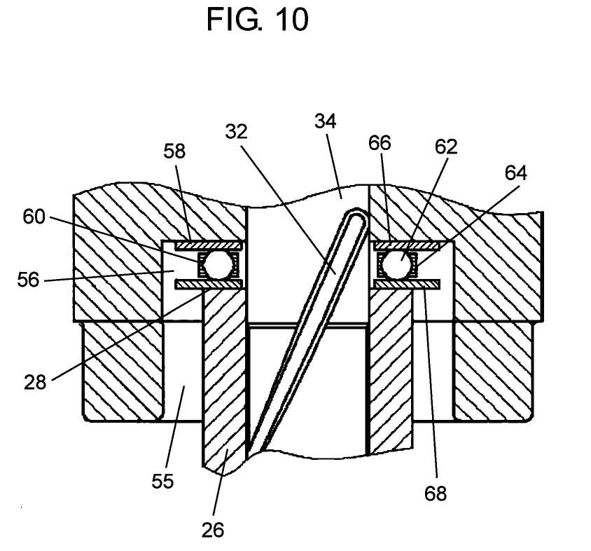

FIG. 11 is a vertical cross-sectional view of another conventional hermetic compressor.

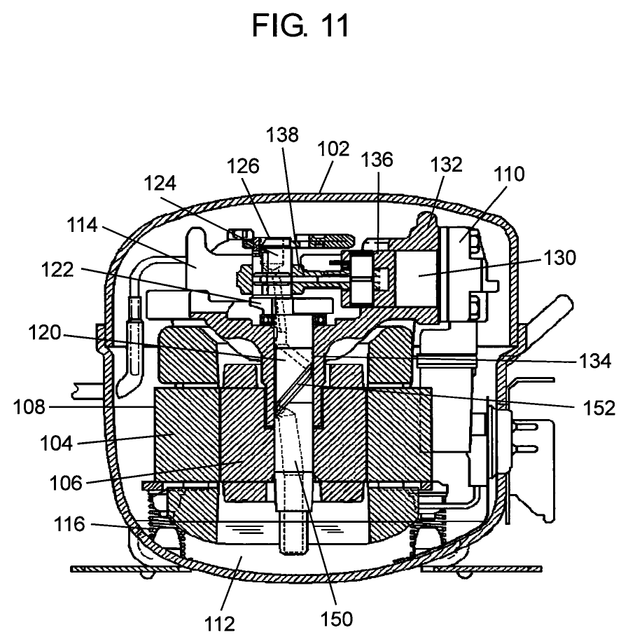

FIG. 12 is an expanded view of essential parts of the another conventional hermetic compressor.

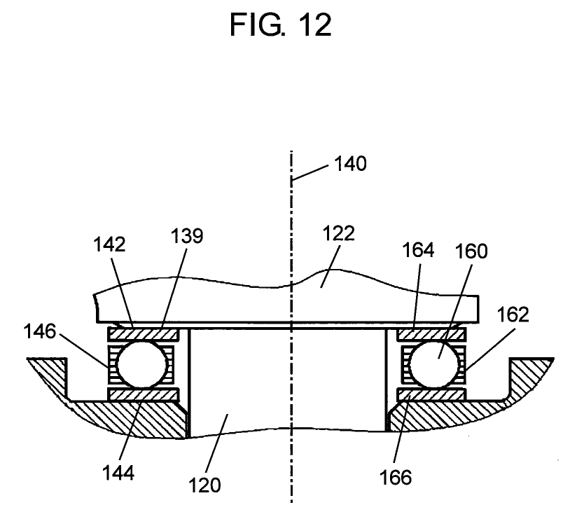

### PREFERRED EMBODIMENTS FOR CARRYING OUT THE INVENTION

Hereinafter, embodiments of the present invention will be described with reference to the accompanying drawings. In the drawings, the dimensions of components are exaggerated for clarity. Further, like reference numerals are attached to the same components, and the descriptions thereof will be omitted.

### First Embodiment

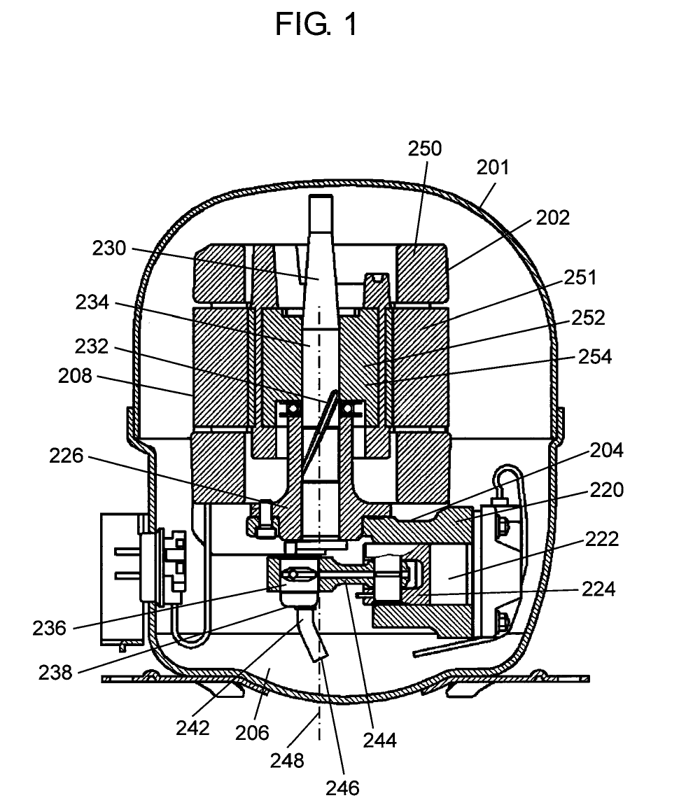

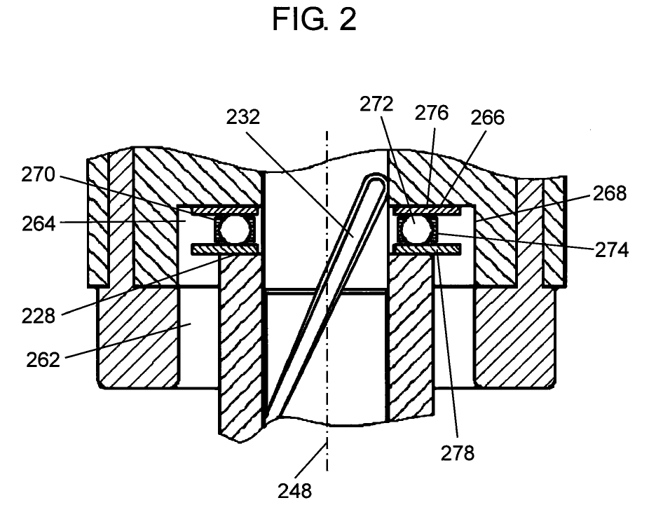

FIG. 1 is a vertical cross-sectional view of a hermetic compressor according to a first embodiment of the present invention. FIG. 2 is an expanded view of essential parts of FIG. 1.

As shown in FIGS. 1 and 2, electric element 202 composed of stator 251 and rotor 252 and compression element 204, which is rotationally driven by electric element 202, are housed in hermetic vessel 201. Further, lubricant oil 206 is stored in the bottom portion of hermetic vessel 201.

Electric element 202 and compression element 204 are integrally assembled so as to form compression mechanism 208. Further, compression mechanism 208 is elastically supported by a plurality of coil springs (not shown) in hermetic vessel 201.

In cylinder block 220 composing compression element 204, cylindrical compression chamber 222 is formed, and piston 224 is fitted into compression chamber 222 so as to freely reciprocate. Main shaft bearing 226 is fixed to the upper portion of cylinder block 220, and thrust surface 228 is formed in the upper side of main shaft bearing 226.

Shaft 230 includes main shaft portion 234, which is supported in a vertical direction by main shaft bearing 226 and has spiral groove 232 formed in the outer circumference thereof, and eccentric shaft portion 236 formed under main shaft portion 234. Further, oil feed pipe 242 formed of a steel pipe is pressed into an oil feeding hole (not shown) formed in lower end 238 of eccentric shaft portion 236, and eccentric shaft portion 236 and piston 224 are connected through connection mechanism 244.

One end of oil feeding pipe 242 communicates with spiral groove 232 from lower end 238 of eccentric shaft portion 236, and lower end opening portion 246 of oil feeding pipe 242 is curved on an extended line of center shaft line 248 of main bearing portion 234 so as to be opened in lubricant oil 206.

Electric element 202 is composed of an induction motor, in which rotary motions are obtained only through connection with a commercial power source and which is easy to handle, and is fixed to the upper side of cylinder block 220 through a bolt (not shown). Further, electric element 202 is composed of stator 251 having winding wire 250 provided thereon and rotor 252 fixed to main shaft portion 234 of shaft 230 through shrinkage fit.

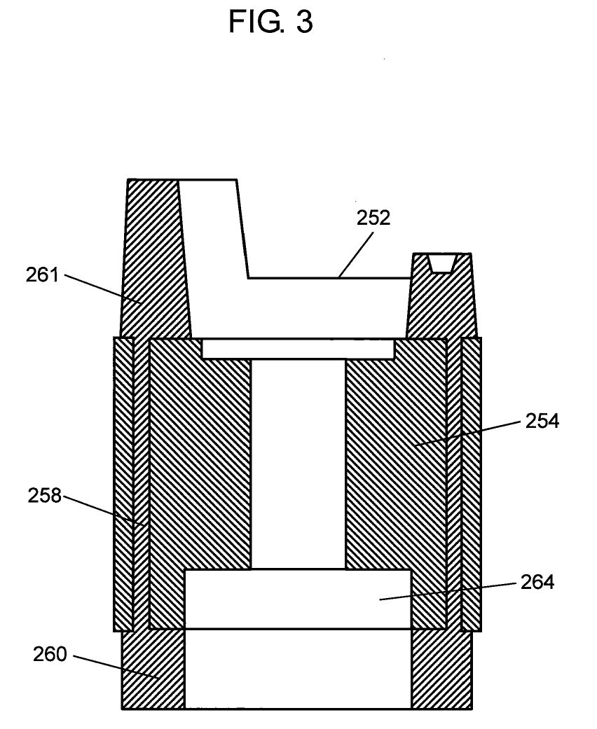

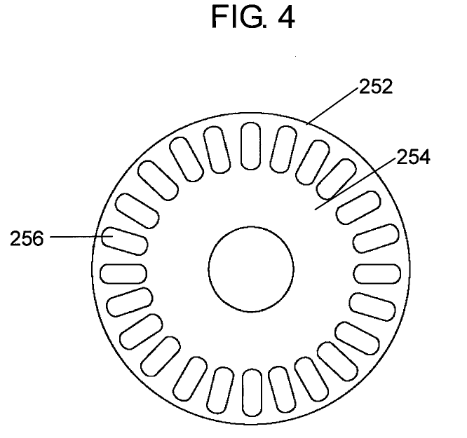

FIG. 3 is a vertical cross-sectional view of rotor 251 according to the first embodiment of the invention. FIG. 4 is a plan cross-sectional view of rotor 251 according to the first embodiment of the invention.

As shown in FIGS. 3 and 4, rotor 252 is constructed in such a cage shape that a plurality of aluminum bars 258 are respectively inserted into a plurality of slots 256 disposed at even intervals in the outer circumferential side of stacked rotor core 254 formed of a steel plate, and both ends of aluminum bars 258 are short-circuited by aluminum short-circuit rings A260 and B261.

As shown in FIGS. 1 to 3, a portion of main shaft bearing 226 is inserted into rotor 252 so as to be overlapped, and counter bore 264 which is a concave portion is provided in lower portion 262 of rotor 252. Therefore, the length of shaft 230 and the height of hermetic vessel 201 are reduced.

Inside counter bore 264 which is a concave portion formed in lower portion 262 of rotor 252, ring-shaped bore plane 266 is formed at substantially right angles to center shaft line 248. Further, on the upper end of main shaft bearing 226, ring-shaped thrust surface 228 is formed at substantially right angles to center shaft line 248. Between bore plane 266 of counter bore 264 and thrust surface 228, thrust-ball bearing 270 is disposed to support shaft 230. Since at least a portion of thrust-ball bearing 270 is inserted into counter bore 264, the periphery thereof is surrounded by inner wall surface 268 of counter bore 264, and the upper side thereof is set in a dead-end state.

Thrust-ball bearing 270 include a plurality of balls 272, holder portion 274 for holding balls 272, and upper lace 276 and lower lace 278 formed on and under balls 272. Further, upper lace 276 is contacted with bore plane 266, and lower lace 278 is contacted with thrust surface 228.

Balls 272 are formed of bearing steel with high abrasion resistance, which is obtained by carburizing and quenching, and upper lace 276 and lower lace 278 are formed of carbon steel with high abrasion resistance, which is subjected to a heat treatment. Further, holder portion 274 of thrust-ball bearing 270 is formed of polymer B which is obtained by polycondensating diaminobutane and adipic acid.

The polymer B has a structure that four methylene groups are regularly arranged between amide linkages. The crystallization speed thereof is high, and the crystallization degree thereof is also high. Specifically, the crystallization degree ranges from 40 to 45%, and the heat resistance, oil resistance, and refrigerant resistance thereof are excellent.

A method of manufacturing the hermetic compressor described in the first embodiment of the invention includes a finished-product process, in which the respective components are assembled into a finished product, and an assembling process in which the inside of the finished product, that is, the hermetic compressor is dried. In the assembling process, the hermetic compressor is heated within a constant temperature furnace, heated at a temperature of more than 150° C., for a predetermined time. Accordingly, the mechanical characteristics of holder portion 274 of thrust-ball bearing 270, formed of the polymer B, can be thermally stabilized.

The operation and action of the hermetic compressor constructed in such a manner will be described.

As shown in FIGS. 1 to 4, when electric power is supplied to electric element 202 from an external power supply (not shown), rotor 252 is rotated, and shaft 230 is rotated in accordance with the rotation of rotor 252. Then, as the rotation of eccentric shaft portion 236 is transmitted to piston 224 through connection mechanism 244, piston 224 reciprocates inside compression chamber 222, and compression element 204 performs a predetermined compression operation.

Accordingly, refrigerant gas is sucked into compression chamber 222 from a cooling system (not shown) so as to be compressed. Then, the refrigerant gas is again discharged into the cooling system.

As this time, one end of oil feeding pipe 242 is pressed into lower end 238 of eccentric shaft portion 236, and lower end opening portion 246 is curved on the extended line of center shaft line 248 of main shaft portion 234. Therefore, lubricant oil 206 is pumped up by a centrifugal force accompanied by the rotation of shaft 230. Then, the respective sliding portions are lubricated with lubricant oil 206, and some of lubricant oil 206 is supplied to thrust surface 228 from spiral groove 232 such that thrust-ball bearing 270 is lubricated.

The weight of shaft 230 and rotor 252 is supported by thrust-ball bearing 270. Further, when shaft 230 is rotated, balls 272 are rolled between upper lace 276 and lower lace 278. Accordingly, torque which rotates shaft 230 is reduced in comparison with a thrust sliding bearing. Therefore, a loss in the thrust bearing can be reduced, and an input can be reduced, which makes it possible to achieve high efficiency.

Next, heat related to thrust-ball bearing 270 will be described.

When the hermetic compressor is operated, for example, when continuous operating time is lengthened, a current continuously flows in winding wire 250 of stator 251, aluminum bars 258 of rotor 252, and short-circuit rings A260 and B260 at both ends of aluminum bars 258, because electric element 202 is formed of an induction motor. Therefore, the temperature of stator 251 and rotor 252 increases to a high temperature, compared with a rotor provided with a permanent magnet.

Further, the larger an operating load, the larger the value of current flowing in electric element 202. Similarly, the temperature of stator 251 and rotor 252 increases.

The heat of the above-described stator 251 is directly conducted into compression element 204 or lubricant oil 206, or is transmitted to hermetic vessel 202 through the refrigerant gas such that the temperatures of the respective portions of the hermetic compressor increase.

As the temperatures of compression element 204, stator 251, and rotor 252 increase, the temperature of thrust-ball bearing 270 increases. Further, thrust-ball bearing 270 is also exposed to lubricant oil 206 with high temperature and low viscosity, which is supplied from spiral groove 232 in order for the lubrication.

Further, a portion of thrust-ball bearing 270 is disposed within counter bore 264 of rotor 252 such that the periphery thereof is surrounded by inner wall surface 268. Accordingly, the upper side of thrust-ball bearing 270 is set in a dead-end state, and the lower side thereof is set to a small space approximate to a closed space surrounded by stator 251, main shaft bearing 226, and cylinder block 220. Therefore, the heat of thrust-ball bearing 270 or the refrigerant gas around thrust-ball bearing 270 is hardly radiated into other components. Accordingly, the temperature increases.

The temperature of holder portion 274 composing thrust-ball bearing 270 also increases due to the above-described reason. Further, since holder portion 274 is interposed between upper lace 276 and lower lace 278, the heat thereof is hardly radiated. Accordingly, the temperature of holder portion 274 increases.

Holder portion 274 is formed of the polymer B of which the heat resistance, oil resistance, and refrigerant resistance are excellent. Accordingly, although a portion of holder portion 274 is disposed within counter bore 264 of which the heat is hardly radiated so that the temperature increases, it is possible to prevent oligomer from being eluted from holder portion 274. Further, it has been found through an experiment that oligomer eluted by lubricant oil 206 can be prevented from adhering to track surfaces of upper lace 276 and lower lace 278.

Since the oligomer is not eluted into lubricant oil 206, the oligomer is not sucked with lubricant oil 206 through oil feeding pipe 242 and does not adhere to the respective sliding portions such as shaft 230 and main shaft bearing 226. As a result, since sliding resistance does not increase in thrust-ball bearing 270, reliability is enhanced.

Through the result, it is considered that, when holder portion 274 is formed of the polymer B, the oligomer can be prevented from being eluted from holder portion 274 because the molecular motions of the polymer B, of which the heat resistance, oil resistance, and refrigerant resistance are excellent, are suppressed even though the temperature increases. As a result, the oligomer is not accumulated as adhering matters on the track surfaces of upper lace 276 and lower lace 278 and does not float as floating matters within lubricant oil 206.

As the oligomer is prevented from being eluted from thrust-ball bearing 270, it is prevented that balls 272 are hardly rolled. Further, the oligomer does not adhere to the respective sliding portions such as shaft 230 and main shaft bearing 226 such that the sliding resistance can be prevented from increasing. As a result, it is possible to provide a high-efficiency and reliable hermetic compressor, in which an increase of input is suppressed.

In the construction where at least a portion of thrust-ball bearing 270 is disposed in counter bore 264 which is a concave portion of stator 252 and the induction motor is used in electric element 202, it is possible to prevent the extraction of the oligomer, even though the continuous operating time is lengthened or the temperature of thrust-ball bearing 270 increases due to an operation condition where an operation load is large. This is because holder portion 274 is formed of the polymer B. Accordingly, when thrust-ball bearing 270 is used, it is possible to provide a high-efficiency and reliable hermetic compressor, in which an increase of input is suppressed.

Further, if moisture permeates into hermetic vessel 201, rust occurs on the inside of compression element 204 or hermetic vessel 201 such that the durability of the hermetic compressor is degraded. Further, if the hermetic compressor is assembled into a cooling system so as to be operated, moisture discharged with refrigerant gas may close a refrigeration system in the cooling system such that cooling defects occur. To prevent such a problem from occurring, a drying process for removing moisture within the hermetic vessel of the hermetic compressor needs to be performed. Specifically, after the constituent parts are assembled into a finished product, i.e. the hermetic compressor, the hermetic compressor is heated and dried in the assembling process.

However, since holder portion 274 is formed of the polymer B of which the heat resistance, oil resistance, and refrigerant resistance are excellent, it is possible to prevent the deformation of holder portion 274 caused by the degradation, even though the hermetic compressor is heated at a temperature of more than 150° C. in the drying process such that the atmospheric temperature of holder portion 274 increases to a high temperature of more than 150° C. Therefore, a member heated at a heating temperature of more than 150° C. for a predetermined time may be used as holder portion 274. Alternately, holder portion 274 assembled into the hermetic compressor may be heated at a heating temperature of more than 150° C.

Using such a method, it is possible to prevent the occurrence of problems such as a reduction in efficiency, an increase in noise, degradation of reliability and so on caused by a loss of input with the deformation of holder portion 274.

Further, since the hermetic compressor can be heated and dried for a short time in a drying furnace where the atmospheric temperature of holder portion 274 increases to at least more than 150° C., it is possible to enhance productivity in the assembling process.

Similarly, even when thrust-ball bearing 270 of the hermetic compressor is operated at the atmospheric temperature of more than 150° C. for a predetermined time, oligomer can be prevented from being eluted from holder portion 274, while the temperature of holder portion 274 increases to more than 150° C. This is because holder portion 274 is formed of the polymer B of which the heat resistance, oil resistance, and refrigerant resistance are excellent. That is, thrust-ball bearing 270 may be operated at an atmospheric temperature of more than 150° C. for a predetermined time, or the hermetic compressor into which thrust-ball bearing 270 is assembled may be operated at an atmospheric temperature of more than 150° C. for a predetermined time.

Using such a method, it is possible to prevent the occurrence of problems such as a reduction in efficiency, an increase in noise, degradation of reliability and so on caused by a loss of input with the deformation of holder portion 274.

In the first embodiment of the invention, the case where the temperature of thrust-ball bearing 270 increases to a high temperature has been described by exemplifying the case where the continuous operating time is lengthened or where the operating load is large. In addition to this case, however, if the case where the temperature of thrust-ball bearing 270 increases to a high temperature is under another condition, this embodiment can be applied in the same manner, and it is possible to prevent the elution of oligomer from holder portion 274.

Further, even when electric element 202 is composed of a motor using a permanent magnet, the same operation and effect can be obtained, while a small amount of heat is generated in comparison with the induction motor.

### Second Embodiment

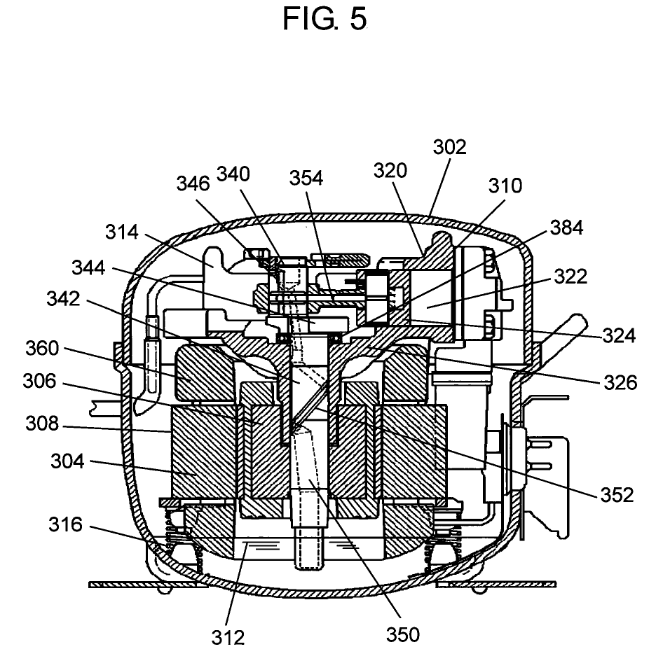

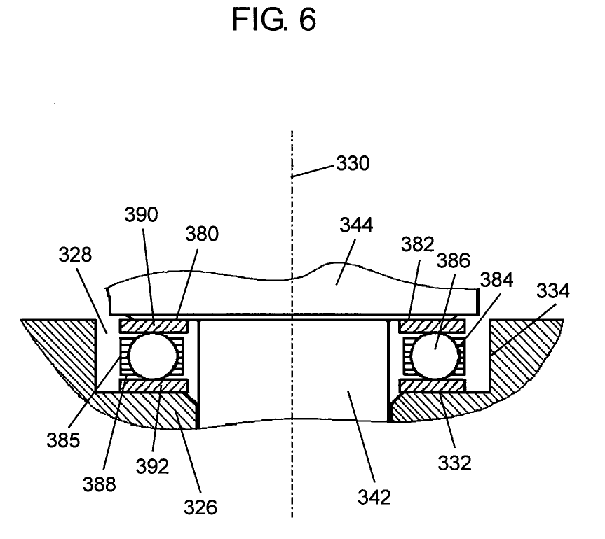

FIG. 5 is a vertical cross-sectional view of a hermetic compressor according to a second embodiment of the invention. FIG. 6 is an expanded view of essential parts of FIG. 5.

As shown in FIGS. 5 and 6, electric element 308 composed of stator 304 and rotor 306 and compression element 310, which is rotationally driven by electric element 308, are housed in hermetic vessel 302, and lubricant oil 312 is stored in the bottom portion of hermetic vessel 302.

Electric element 308 and compression element 310 are integrally assembled so as to form compression mechanism 314. Further, compression mechanism 314 is elastically supported by a plurality of coil springs 316 in hermetic vessel 302.

Next, main components of compression element 310 will be described.

In cylinder block 320 composing compression element 310, cylindrical compression chamber 322 is formed, and piston 324 is fitted into compression chamber 322 so as to freely reciprocate. Cylinder block 320 has main shaft bearing 326 formed in the lower portion thereof, and main shaft bearing 326 has thrust groove 328 formed in the upper portion thereof.

On the bottom of thrust groove 328, upper end surface 332 is formed at substantially right angles to shaft center 330 of main shaft bearing 326. The periphery of upper end surface 332 is surrounded by inner wall surface 334.

Shaft 340 has eccentric shaft portion 346 formed through shaft portion 342 and flange portion 344. Main shaft portion 342 is supported in a vertical direction by main shaft bearing 326 and includes oil feeding mechanism 350 of which one end communicates with lubricant oil 312 stored in hermetic vessel 302 and oil feeding groove 352 which supplies some of lubricant oil 312, pumped up to main shaft portion 342 by oil feeding mechanism 350, to upper end surface 332. Further, eccentric shaft portion 346 and piston 324 are connected through connection mechanism 354.

Electric element 308 is formed of an induction motor, which can obtain rotary motions only through connection with a commercial power source and is easy to handle. Further, electric element 308 is composed of stator 304, which is fixed to the lower side of cylinder block 320 through a bolt (not shown) and has winding wire 360 provided thereon, and rotor 306 fixed to main shaft portion 342 of shaft 340 through shrinkage fit.

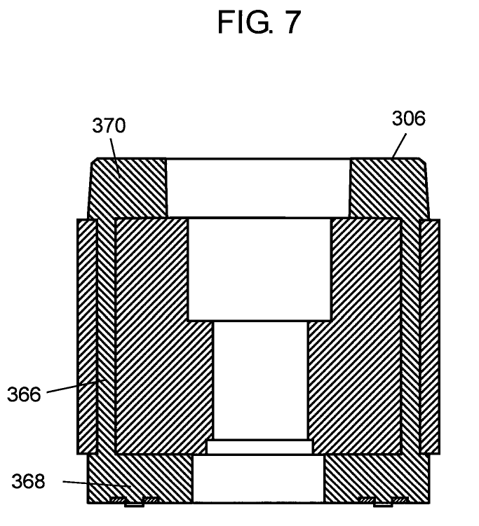

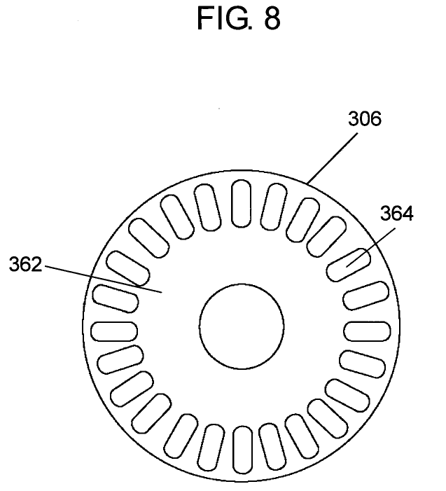

FIG. 7 is a vertical cross-sectional view of rotor 306 according to the second embodiment of the invention. FIG. 8 is a plan cross-sectional view of rotor 306 according to the second embodiment of the invention.

As shown in FIGS. 7 and 8, rotor 306 is constructed in such a cage shape that a plurality of aluminum bars 366 are respectively inserted into a plurality of slots 364 disposed at even intervals in the outer circumferential side of stacked rotor core 362 formed of a steel plate, and both ends of aluminum bars 366 are short-circuited by aluminum short-circuit rings A368 and B370.

On lower portion 380 of flange portion 344 of shaft 340, upper lace receiving surface 382 is formed at substantially right angles to shaft center 330 of main shaft portion 342. Further, between upper lace receiving surface 382 and upper end surface 332 of main shaft bearing 326, thrust-ball bearing 384 is disposed so as to support shaft 340. Thrust-ball bearing 384 is inserted into thrust groove 328 of main shaft portion 342 such that at least a portion of outer surface 385 of thrust-ball bearing 384 is surrounded by at least a portion of inner wall surface 334 of thrust groove 328 and the lower side of thrust-ball bearing 384 is set in a dead-end state.

As at least a portion of thrust-ball bearing 384 is inserted into thrust groove 328, the position of eccentric shaft portion 346 can be suppressed. Accordingly, the height of hermetic vessel 302 can be reduced.

Since a portion of the outside of thrust-ball bearing 384 in thrust groove 328 is surrounded by portions of thrust groove 328 and main shaft bearing 326, noise of thrust-ball bearing 384 transmitted to the outside of thrust groove 328 can be reduced. In addition, as thrust groove 328 plays a roll of storing oil, thrust groove 328 can smoothly supply oil to thrust-ball bearing 384.

Thrust-ball bearing 384 includes a plurality of balls 386, holder portion 388 for holding balls 386, and upper lace 390 and lower lace 392 disposed on and under balls 386. Further, upper lace 390 is contacted with upper lace receiving surface 382, and lower lace 392 is contacted with upper end surface 332.

Balls 386 are formed of bearing steel with high abrasion resistance, which is obtained by carburizing and quenching, and upper lace 390 and lower lace 392 are formed of carbon steel with high abrasion resistance, which is subjected to a heat treatment. Further, holder portion 388 of thrust-ball bearing 384 is formed of polymer B which is obtained by polycondensating diaminobutane and adipic acid.

As described in the first embodiment, the polymer B has a structure that four methylene groups are regularly arranged between amide linkages. The crystallization speed thereof is high, and the crystallization degree thereof is also high. Specifically, the crystallization degree ranges from 40 to 45%, and the heat resistance, oil resistance, and refrigerant resistance thereof are excellent.

A method of manufacturing the hermetic compressor described in the second embodiment of the invention includes a finished-product process, in which the respective components are assembled into a finished product, and an assembling process in which the inside of the finished product, that is, the hermetic compressor is dried. In the assembling process, the hermetic compressor is heated within a constant temperature furnace, heated at a temperature of more than 150° C., for a predetermined time. Accordingly, the mechanical characteristics of holder portion 388 of thrust-ball bearing 384, formed of the polymer B, can be thermally stabilized.

Now, the operation and action of the hermetic compressor constructed in such a manner will be described.

As shown in FIGS. 5 to 8, when electric power is supplied to electric element 308 from an external power supply (not shown), rotor 306 is rotated, and shaft 340 is rotated in accordance with the rotation of rotor 306. Then, as the rotation of eccentric shaft portion 346 is transmitted to piston 324 through connection mechanism 354, piston 324 is reciprocated inside compression chamber 322, and compression element 310 performs a predetermined compression operation.

Accordingly, refrigerant gas is sucked into compression chamber 322 from a cooling system (not shown) so as to be compressed. Then, the refrigerant gas is again discharged into the cooling system.

At this time, shaft 340 pumps up lubricant oil 312 through oil feeding mechanism 350 of main shaft portion 342. Then, the respective sliding portions are lubricated with lubricant oil 312, and some of lubricant oil 312 is supplied to upper end surface 332 from oil feeding groove 352 such that thrust-ball bearing 384 is lubricated.

The weight of shaft 340 is supported by thrust-ball bearing 384. Further, when shaft 340 is rotated, balls 386 are rolled between upper lace 390 and lower lace 392. Accordingly, torque which rotates shaft 340 is reduced in comparison with a thrust sliding bearing. Therefore, a loss in the thrust bearing can be reduced, and an input can be reduced, which makes it possible to achieve high efficiency.

Next, heat related to thrust-ball bearing 384 will be described.

When the hermetic compressor is operated, for example, when continuous operating time is lengthened, a current continuously flows in winding wire 360 of stator 304, aluminum bars 366 of rotor 306, and short-circuit rings A368 and B370 at both ends of aluminum bars 366, because electric element 308 is composed of an induction motor. Therefore, the temperature of stator 304 and rotor 306 increases to a high temperature, compared with a rotor provided with a permanent magnet.

Further, the larger an operating load, the larger the value of current flowing in electric element 308. Similarly, the temperature of stator 304 and rotor 306 increases.

The heat of the above-described stator 304 is directly conducted into compression element 310 or lubricant oil 312, or is transmitted to hermetic vessel 302 through the refrigerant gas such that the temperatures of the respective portions of the hermetic compressor increase.

As the temperatures of compression element 310, stator 304, and rotor 306 increase, the temperature of thrust-ball bearing 384 increases. Further, thrust-ball bearing 384 is also exposed to lubricant oil 312 with high temperature and low viscosity, which is supplied from oil feeding groove 352 in order for the lubrication.

Further, a portion of thrust-ball bearing 384 is disposed within thrust groove 328 of main shaft bearing 326. Further, the periphery of outer surface 385 of thrust-ball bearing 384 is surrounded by inner wall surface 334 of thrust groove 328 such that the lower side of thrust-ball bearing 384 is set in a dead-end state and the upper side thereof is set to a small space approximate to a closed space surrounded by flange portion 344 and cylinder block 320. In such a structure, the heat of thrust-ball bearing 384 or the refrigerant gas around thrust-ball bearing 384 is hardly radiated. Accordingly, the temperature increases.

The temperature of holder portion 388 composing thrust-ball bearing 384 also increases due to the above-described reason. Further, since holder portion 388 is interposed between upper lace 390 and lower lace 392, the heat thereof is hardly radiated. Accordingly, the temperature of holder portion 388 increases.

Holder portion 388 is formed of the polymer B of which the heat resistance, oil resistance, and refrigerant resistance are excellent. Accordingly, although a portion of holder portion 388 is disposed within thrust groove 328 in which the heat is hardly radiated so that the temperature increases, it is possible to prevent oligomer from being eluted from holder portion 388. Further, it has been found through an experiment that the oligomer eluted by lubricant oil 312 can be prevented from adhering to track surfaces of upper lace 390 and lower lace 392.

Since the oligomer is not eluted into lubricant oil 312, the oligomer is not sucked with lubricant oil 312 through oil feeding mechanism 350 and does not adhere to the respective sliding portions such as shaft 340 and main shaft bearing 326. As a result, since sliding resistance does not increase in thrust-ball bearing 384, reliability is enhanced.

Through the result, it is considered that when holder portion 388 is formed of the polymer B, the oligomer can be prevented from being eluted from holder portion 388 because the molecular motions of the polymer B, of which heat resistance, oil resistance, and refrigerant resistance are excellent, are suppressed even though the temperature increases. As a result, the oligomer is not accumulated as adhering matters on the track surfaces of upper lace 390 and lower lace 392 and does not float as floating matters within lubricant oil 312.

As the oligomer is prevented from being eluted from thrust-ball bearing 384, it is prevented that balls 386 are hardly rolled. Further, the oligomer does not adhere to the respective sliding portions such as shaft 340 and main shaft bearing 326 such that the sliding resistance can be prevented from increasing. As a result, it is possible to provide a high-efficiency and reliable hermetic compressor, in which an increase in input is suppressed.

In the construction where at least a portion of thrust-ball bearing 384 is disposed in thrust groove 328 of main shaft bearing 326 and the induction motor is used in electric element 308, it is possible to prevent the extraction of the oligomer, even though the continuous operating time is lengthened or the temperature of thrust-ball bearing 384 increases due to an operation condition where an operation load is large. This is because holder portion 388 is formed of the polymer B. Accordingly, when thrust-ball bearing 384 is used, it is possible to provide a high-efficiency and reliable hermetic compressor, in which an increase in input is suppressed.

Further, if moisture permeates into hermetic vessel 302, rust occurs on the inside of compression element 310 or hermetic vessel 302 such that the durability of the hermetic compressor is degraded. Further, if the hermetic compressor is assembled into a cooling system so as to be operated, moisture discharged with refrigerant gas may close a refrigeration system within the cooling system such that cooling defects occur. To prevent such a problem from occurring, a drying process for removing moisture within the hermetic vessel of the hermetic compressor needs to be performed. Specifically, after the constituent parts are assembled into a finished product, i.e. the hermetic compressor, the hermetic compressor is heated and dried in the assembling process.

However, since holder portion 388 is formed of the polymer B of which the heat resistance, oil resistance, and refrigerant resistance are excellent, it is possible to prevent the deformation of holder portion 388 caused by the degradation, even though the hermetic compressor is heated at a heating temperature of more than 150° C. in the drying process such that the atmospheric temperature of holder portion 388 increases to more than 150° C. Therefore, a member heated at a heating temperature of more than 150° C. for a predetermined time may be used as holder portion 388. Alternately, holder portion 388 assembled into the hermetic compressor may be heated at a temperature of more than 150° C.

Using such a method, it is possible to prevent the occurrence of problems such as a reduction in efficiency, an increase in noise, degradation of reliability and so on caused by a loss of input with the deformation of holder portion 388.

Further, since the hermetic compressor can be heated and dried for a short time in a drying furnace where the atmospheric temperature of holder portion 388 increases to at least more than 150° C., it is possible to enhance productivity in the assembling process.

Similarly, even when thrust-ball bearing 384 of the hermetic compressor is operated at the atmospheric temperature of more than 150° C. for a predetermined time, the oligomer can be prevented from being eluted from holder portion 388, while the temperature of holder portion 388 increases to more than 150° C. This is because holder portion 388 is formed of the polymer B of which the heat resistance, oil resistance, and refrigerant resistance are excellent. That is, thrust-ball bearing 384 may be operated at an atmospheric temperature of more than 150° C. for a predetermined time, or the hermetic compressor into which thrust-ball bearing 384 is assembled may be operated at a temperature of more than 150° C. for a predetermined time.

Using such a method, it is possible to prevent the occurrence of problems such as a reduction in efficiency, an increase in noise, degradation of reliability and so on caused by a loss of input with the deformation of holder portion 274.

In the second embodiment of the invention, the case where the temperature of thrust-ball bearing 384 increases to a high temperature has been described by exemplifying the case where the continuous operating time is lengthened or where the operating load is large. In addition to this case, however, if the case where the temperature of thrust-ball bearing 384 increases to a high temperature is under another condition, this embodiment can be applied in the same manner, and it is possible to prevent the elution of oligomer from holder portion 388.

Further, although a portion of the outside of thrust-ball bearing 384 is surrounded by a portion of cylinder block 320, the same operation and effect can be obtained.

Further, even when electric element 308 is composed of a motor using a permanent magnet, the same operation and effect can be obtained, while a small amount of heat is generated in comparison with the induction motor.

### INDUSTRIAL APPLICABILITY

According to the hermetic compressor of the invention, as the holder portion is formed of polymer which is obtained by polycondensating diaminobutane and adipic acid, it is possible to provide a high-efficiency and reliable hermetic compressor, in which an increase in input is suppressed.

Therefore, the hermetic compressor can be applied a vending machine, a refrigeration showcase, a dehumidifier as well as a refrigeration system such as a refrigerator.

### REFERENCE NUMERALS

201,302 hermetic vessel
202,308 electric element
204,310 compression element
206,312 lubricant oil
208,314 compression mechanism
220,320 cylinder block
222,322 compression chamber
224,324 piston
226,326 main shaft bearing
228 thrust surface
230,340 shaft
232 spiral groove
234,342 main shaft portion
236,346 eccentric shaft portion
238 lower end
242 oil feed pipe
244,354 connection mechanism
246 lower end opening portion
248 center shaft line
250,360 winding wire
251,304 stator
252,306 rotor
254,362 rotor core
256,364 slot
258,366 aluminum bar
260,368 short-circuit ring A
261,370 short-circuit ring B
262,380 lower portion
264 counter bore
266 bore plane
268,334 inner wall surface
270,384 thrust-ball bearing
272,386 ball
274,388 holder portion
276,390 upper lace
278,392 lower lace
316 coil spring
328 thrust groove
330 shaft center
332 upper end surface
344 flange portion
350 oil feeding mechanism
352 oil feeding groove
382 upper lace receiving surface
385 outer surface

1. A hermetic compressor comprising a hermetic vessel in which lubricant oil is stored and an electric element having a stator and a rotor provided therein and a compression element driven by the electric element are housed,
wherein the compression element includes:
a shaft which has a main shaft portion and an eccentric shaft portion;
a cylinder block which forms a compression chamber; a main shaft bearing which is formed in the cylinder block and supports the main shaft bearing of the shaft;
a piston which reciprocates inside the compression chamber;
a connection mechanism which connects the piston to the eccentric shaft portion; and
a thrust-ball bearing which has a plurality of balls and a holder portion for holding the balls, the holder portion being formed of polymer obtained by polycondensating diaminobutane and adipic acid.

2. The hermetic compressor of claim 1, wherein the rotor is fixed to the main shaft portion of the shaft through shrinkage fit, and the thrust-ball bearing is provided between the rotor and the main shaft portion.

3. The hermetic compressor of claim 2, wherein at least a portion of the thrust-ball bearing is disposed in a counter bore which is a concave portion of the rotor.

4. The hermetic compressor of claim 1, wherein the eccentric shaft portion of the shaft is formed through the main shaft portion and a flange portion, and the thrust-ball bearing is disposed between the flange portion and the upper end surface of the main shaft bearing.

5. The hermetic compressor of claim 4, wherein at least a portion of the outside of the thrust-ball bearing is surrounded by at least a portion of the cylinder block or the main shaft bearing.

6. The hermetic compressor of claim 1, wherein the electric element is an induction motor.

7. The hermetic compressor of claim 1, wherein the holder portion is formed of a member heated at a heating temperature of more than 150° C. for a predetermined time.

8. The hermetic compressor of claim 1, wherein the thrust-ball bearing is operated at an atmospheric temperature of more than 150° C. for a predetermined time.

9. A method of manufacturing a hermetic compressor comprising a hermetic vessel in which lubricant oil is stored and an electric element having a stator and rotor provided therein and a compression element driven by the electric element are housed, wherein the compression element includes a shaft which has a main shaft portion and an eccentric shaft portion; a cylinder block which forms a compression chamber; a main shaft bearing which is formed in the cylinder block and supports the main shaft bearing of the shaft; a piston which reciprocates inside the compression chamber; a connection mechanism which connects the piston to the eccentric shaft portion; and a thrust-ball bearing which has a plurality balls and a holder portion for holding the balls,
the method comprising:
integrating the electric element and the compression element, which are obtained by assembling respective constituent members, into the hermetic compressor as a finished product; and
heating and drying the finished product,
wherein the holder portion is formed of polymer obtained by polycondensating diaminobutane and adipic acid and is heated at a temperature of more than 150° C. in the heating and drying of the finished product.

10. The hermetic compressor of claim 2, wherein the thrust-ball bearing is operated at an atmospheric temperature of more than 150° C. for a predetermined time.

11. The hermetic compressor of claim 3, wherein the thrust-ball bearing is operated at an atmospheric temperature of more than 150° C. for a predetermined time.
